(19) United States
(12) Patent Application Publication
(10) Pub. No.: US 2008/0184966 A1
(43) Pub. Date: Aug. 7, 2008

(54) En Very Compact Device For Adjusting the Compression Ratio of an Internal Combustion Engine

(76) Inventor: Michel Marchisseau, Limoges (FR)

Correspondence Address: Michel MARCHISSEAU, 33, rue Condorcet, Limoges, 87100, omitted

(21) Appl. No.: 11/817,248

(22) PCT Filed: Feb. 27, 2006
(86) PCT No.: PCT/FR06/00430

§ 371 Date: Aug. 28, 2007

(30) Foreign Application Priority Data
Feb. 28, 2005 (FR) 0501983

(51) Int. Cl. F02D 15/02

(52) U.S. Cl. 123/48 B

(57) ABSTRACT

The invention relates to a device and method for adjusting the compression ratio of internal combustion engines during the operation thereof. According to the invention, the angular position of an eccentric (18), which is solidly connected to at least one lateral flange (21c, 21b) and which is slidably housed in the bore in the rod big end, is controlled with at least one cylinder (34a, 34b, 34c, 34d) and a contactless measuring sensor (43).

### TECHNICAL FIELD

The present invention refers to a device adjustment of the compression ratio of an internal combustion engine and to a process allowing the use of such a device.

It more particularly relates to a device which can change the compression ratio of this engine by modifying the dead volume of the combustion chamber at the high dead point of the piston.

### FORMER TECHNIQUE

He is already known, by document EP 0.066.350, a device of adjustment of the compression ratio of an engine in which this engine includes/understands a crankshaft, a cylinder inside whose a piston slides in an alternative translative movement via a rod connected to that the piston and the crankshaft, this piston delimiting with the top of the cylinder a combustion chamber comprising a volume died at the point dead high of this piston, and a rotary eccentric, of tractor drawn type, intercalated between the rod and the piston. This eccentric, in a first position, makes it possible the piston to reduce the dead volume of the combustion chamber while increasing the compression ratio and to increase this died volume, for another position of this eccentric, while obtaining a lower compression ratio. To obtain these various positions, the boring of the big end present of the axial grooves which cooperate with a locking pin laid out in the eccentric, radially compared to the axis of the known as eccentric in order to immobilize it in one of the positions corresponding to of the aforesaid axial grooves of the rod.

This device of adjustment of the compression ratio presents many advantages: it is localized in the moving element and is energy saver: it is actuated by energy provided directly by the moving element. Its establishment is not very constraining: it affects neither the combustion chamber neither the connections with the exhaust, or the bodies of distribution or the transmission, nor the weight of the piston. It is nevertheless perfectible.

The big end is very bulky in order to place at the same time the eccentric and the mechanical locking mechanism. The ordering of the device of adjustment of the compression ratio must forward by several mobile bodies the ones compared to the others: the casing, the crankshaft and finally the eccentric related to the rod.

The mechanical system of locking is necessarily subjected to elevated levels of friction and constraints, and even possibly with shocks. This aspect combined with the little of place available in the eccentric, affects the time life.

More recent designs present an establishment different from such a system of mechanical locking. It is the case of the document JP 3026834 where the locking pin is placed in the stage of the crankshaft or of the document OF 10243023 where the fingers or the catches are placed in the crank pin of the crankshaft. These designs also do not have a minimized volume: indeed, these locking mechanisms being integrated in near total in parts of the crankshaft by which the couple of the engine forwards, the of the aforesaid obstructions left the crankshaft are necessarily increased to make it possible the crankshaft to resist the constraints generated by the couple which it transmits.

Moreover these mechanical systems of locking have a finished number of positions. They thus do not make it possible to obtain a continuous adjustment of the compression ratio on a beach. In another type of device of variation of the compression ratio, like described better in patent application EP 1.247.958, the eccentric is not an eccentric of the tractor drawn type but a motorized eccentric. An electrical motor or hydraulics actuates an endless screw irreversible which cooperates with a toothed sector of the eccentric. This device presents a major disadvantage because the electrical motor or hydraulics must thwart various frictions and the various inertias, in particular those of the moving element of the internal combustion engine, to motorize the eccentric. However these frictions and these inertias are very important. The aforementioned electrical motor or hydraulics is thus necessarily cumbersome. Moreover, energy to supply this engine must be provided by an additional body. The output is thus heavily penalized.

### DISCLOSED INVENTION

The present invention proposes to cure the disadvantages mentioned above thanks to a device of adjustment of the compression ratio energy saver, of a compactness on the best level while being easily compatible with high timelife. For this purpose, the present invention relates to a device of adjustment of the compression ratio of an internal combustion engine including at least a cylinder with a combustion chamber, a moving element comprising a removable piston in translation under the action of a rod bound by an axis to that the piston and connected to a crank pin of a crankshaft, the aforementioned piston carrying out a race between a top dead center and a dead bottom center while letting remain a volume died at the high dead point of the known as piston, the device including between the big end and the crank pin of the crankshaft a rotary eccentric making it possible to adjust compression the ratio, the device also including methods of control of displacement eccentric, characterized in that the methods of control include/understand at least a kinematic connection without bolt between a radial protuberance interdependent of the eccentric and a mechanism of adjustment in position compared to the crankshaft, the aforementioned mechanism being integrated in one of the two blanks of the crankshaft, the aforementioned kinematic connection and the aforementioned mechanism of adjustment in position compared to the crankshaft on the one hand being laid out in major part or entirely apart from the crank pin, of the stage and the lever connecting the crank pin to the stage of the crankshaft, and on the other hand integrated in a volume whose point furthest away from the axis of the crankshaft describes a circle, during the rotation of the engine, of a diameter of the same order of magnitude or lower than the diameter of the largest circle describes by the big end or of the largest circle describes by the blanks of the crankshaft.

The present invention associates several determining advantages, which all are never joined together simultaneously in the designs described in former art. The first advantage is a compactness on the best level on all the parts constitutive of the device. That concerns:

1—The eccentric placed in the big end can be dimensioned with the most compact dimensions since it is interdependent of a radial protuberance by which displacements and the mechanical constraints related to the control of its position forward; 2—The obstruction of the crankshaft can be also to be dimensioned with dimensions the most compact since the methods of control of the displacement of the eccentric are laid out in the zones available swept by a conventional crankshaft, in major part or entirely apart from the crank pin, of the stage and the lever connecting the crank pin to the stage of the crankshaft, therefore the aforementioned methods of control according to the invention do not require an increase in the obstruction of the crankshaft whereas their integration does not weaken the mechanical resistance of the crankshaft; 3—The obstruction necessary to the moving element can also be minimal since the methods of control of the displacement of the eccentric embarked on the moving element are integrated in the geometrical cylinder defines by the rotation of the big end or by the rotation of the blank of the crankshaft.

The second advantage is a volume available important to place the methods of control of the displacement of the eccentric. This second advantage is compatible with the first above-mentioned one because according to the invention the average of the aforesaid main components of control: the kinematic connection and the mechanism of adjustment in position compared to the crankshaft, are integrated in the blank of the crankshaft, contiguous space with the lever, the crank pin and the stage of the crankshaft. This volume is important and available in the obstruction usual of the moving element of a traditional engine.

The third advantage is the aptitude for high time lives related to the robustness of the possible designs with the present invention. This third advantage is related to specificities of this invention enumerated below: a) Importance of volume available to integrate the mechanism of adjustment in position compared to the crankshaft and its kinematic connection with the eccentric, which makes it possible to dimension these components without penalizing liberally the obstruction total; b) The aforementioned kinematic connection does not comprise a bolt, it is thus not weakened by this type of system; c) The radial protuberance interdependent of the eccentric fulfills a simple function, it is thus easy to carry out in a robust way; d) The aforementioned radial protuberance takes part in the mechanical resistance of the eccentric and distributes the constraints in its section; e) The eccentric is free from part or of form constitutive of a bolt, it is thus not weakened by this type of system.

The characteristics of this invention thus associate a time life raised with a compactness on the best level and a large volume for the integration of the device.

According to a first complementary characteristic, the methods of control of the displacement of the eccentric according to the invention make it possible to carry out a continuous adjustment of the compression ratio on its beach of variation. This characteristic associates with the above mentioned advantages of this invention the possibility of adjusting in any point the compression ratio to the optimal value.

According to one second complementary characteristic, the methods of control of the displacement of the eccentric according to the invention use energy taken on the moving element to move the eccentric. This characteristic associates with the above mentioned advantages of this invention the possibility of adjusting the compression ratio with a great reactivity and a great energy sobriety of the device. Moreover, this characteristic also associates the advantage of making it possible to take on the peripherals of the moving element or the internal combustion engine only the energy of order necessary to the device according to the invention.

According to a third complementary characteristic, the methods of control of the displacement of the eccentric according to the invention include/understand two units placed on both sides eccentric and made up each one at least of a kinematic connection without bolt related to a radial protuberance interdependent of the eccentric and of a mechanism of adjustment in position compared to the crankshaft. This characteristic makes it possible to reinforce the robustness for the moving elements very strongly solicited.

According to a fourth complementary characteristic, the two mechanisms of adjustment in position compared to the crankshaft pertaining to the two whole placed on both sides of the eccentric, cities in the preceding paragraph, are kinematically dependant so that they take part in a way roughly equal to control of the displacement of the eccentric. This characteristic to reinforce the robustness of the unit.

According to a fifth complementary characteristic, the mechanism of adjustment in position compared to the crankshaft pertaining to the methods of control of the displacement of the eccentric according to the invention comprises at least a linear actuator. The advantage of a linear actuator lies in simplicity.

According to a sixth complementary characteristic, the aforementioned mechanism of adjustment in position of the eccentric compared to the crankshaft according to the invention comprises two linear actuators from which the axes are distinct. These two actuators can be for simple purpose. Thus each actuator can work by simple push and act as direction opposed on the orientation of the eccentric. This design makes it possible to simplify the connections kinematics. From elsewhere, the obstruction axial of an actuator for simple purpose is lower than that of an actuator for double purpose.

According to a seventh characteristic complementary to the preceding one, the two linear actuators are placed from and of other of the crank pin and the stage of the crankshaft. This design facilitates integration of the aforesaid actuators in the blank of the crankshaft.

According to an eighth characteristic complementary to the invention, the coefficient of friction between boring of the eccentric and the crank pin of the crankshaft are lower than seventeen hundredths. This value of the coefficient of friction has the advantage of making it possible the eccentric to be tractor drawn for many applications. The definition of a tractor drawn eccentric is specified in the description of the preferred mode of realization.

According to ninth a complementary characteristic, the coefficient of friction between the eccentric and the boring of the big end is higher than twenty hundredths. This value of the coefficient of friction has the advantage of making it possible the eccentric not to be tractor drawn for many applications. The advantage is that the eccentric thus does not turn in absence of a couple generated by a specific actuator. The eccentric thus preserves its angular position without requiring of specific means to block it or to maintain it.

According to a tenth characteristic which constitutes an alternative of the preceding one, the methods of control of the displacement of the eccentric according to the invention measures a distance using a transmitter without contact, between a position interdependent of the casing of the engine and one of the parts which moves compared to the crankshaft to adjust the compression ratio. The measurement of a distance from this type has the advantage of making it possible the device to determine without significant error the compression ratio. From elsewhere, a contactless sensor makes it possible to obtain one high time life and a great reliability for this measurement.

The radial protuberance interdependent of the eccentric related to the kinematic connection belonging to the methods of control of the displacement of the eccentric can be a flange interdependent of the eccentric. This design has the advantage of distributing the constraints of control of the position of the eccentric on the three hundred and sixty degrees of the eccentric.

The methods of control of the displacement of the eccentric according to the invention have means of ordering of the mechanism of adjustment in position compared to the crankshaft.

The invention relates to also a process of adjustment of the compression ratio of an internal combustion engine, the aforementioned driving including at least a cylinder with a combustion chamber, a moving element comprising a mobile piston in translation under the action of a rod bound by an axis to that the piston and connected to a crank pin of a crankshaft, the aforementioned piston carrying out a race between a top dead center and a dead bottom center while letting remain a volume died at the high dead point of the known as piston, characterized in that the process consists with:
to determine the compression ratio wished of the engine;
to determine the position which one of the parts must reach which moves compared to the crankshaft according to a continuous function of the compression ratio, with a given swing angle of the crankshaft, to obtain the compression ratio wished;
to control the distance to that the swing angle of the crankshaft used with the preceding phase, between a position interdependent of the casing of the engine and the aforementioned part which moves compared to the crankshaft according to a continuous function of the compression ratio.

### SUMMARY DESCRIPTION OF THE DRAWINGS

The other characteristics and advantages of the invention will appear with the reading of the description which will follow, given on a purely basis only illustrative and nonrestrictive, and to which are annexed:

FIG. 1 shows, in sight burst, the internal combustion engine according to a plan parallel with the axes of the crankshaft and cylinder;

FIG. 2 shows the internal combustion engine according to a plan of cut parallel the axis of the cylinder and perpendicular to the crankshaft;

FIG. 3 shows, in sight burst according to a plan parallel with the axes of the crankshaft and cylinder, the internal combustion engine adjusted at its maximum compression ratio equipped with the device carried out according to a particular mode of realization;

FIG. 4 shows the internal combustion engine adjusted at its maximum compression ratio according to a plan of cut parallel the axis of the cylinder and perpendicular to the crankshaft, equipped with device carried out according to a particular mode of realization;

FIG. 5 shows, in sight burst according to a plan parallel with the axes of the crankshaft and cylinder, the internal combustion engine adjusted at its minimum compression ratio equipped with the device carried out according to a particular mode of realization;

FIG. 6 shows the internal combustion engine adjusted at its minimum compression ratio according to a plan of cut parallel the axis of the cylinder and perpendicular to the crankshaft, equipped with device carried out according to a particular mode of realization;

FIG. 7 shows, the internal combustion engine equipped with its drivers of ordering of the device;

FIG. 8 shows the mechanical components embarked on the moving element of the device of adjustment of the compression ratio;

FIG. 9 shows the crankshaft and the small end equipped with the device of adjustment of the compression ratio for the engines strongly charged;

FIG. 10 shows an alternative of the elements of transmission of the ordering of the device of adjustment of the compression ratio;

FIG. 11 shows the crankshaft crosses from there for an alternative of the device of adjustment of the compression ratio;

FIG. 12 shows, according to a plan of cut parallel the axis of the cylinder and perpendicular to the crankshaft, the engine equipped with the device carried out according to another manner of carrying out the invention in hydraulic version;

FIG. 13 shows the hydraulic diagram for another manner of carrying out the invention in hydraulic version;

FIG. 14 presents a graph of rotation of the eccentric in function the pressure of piloting;

FIG. 15 shows the crankshaft crosses from there for another alternative of the device of adjustment of the compression ratio.

### MANNERS OF CARRYING OUT THE INVENTION

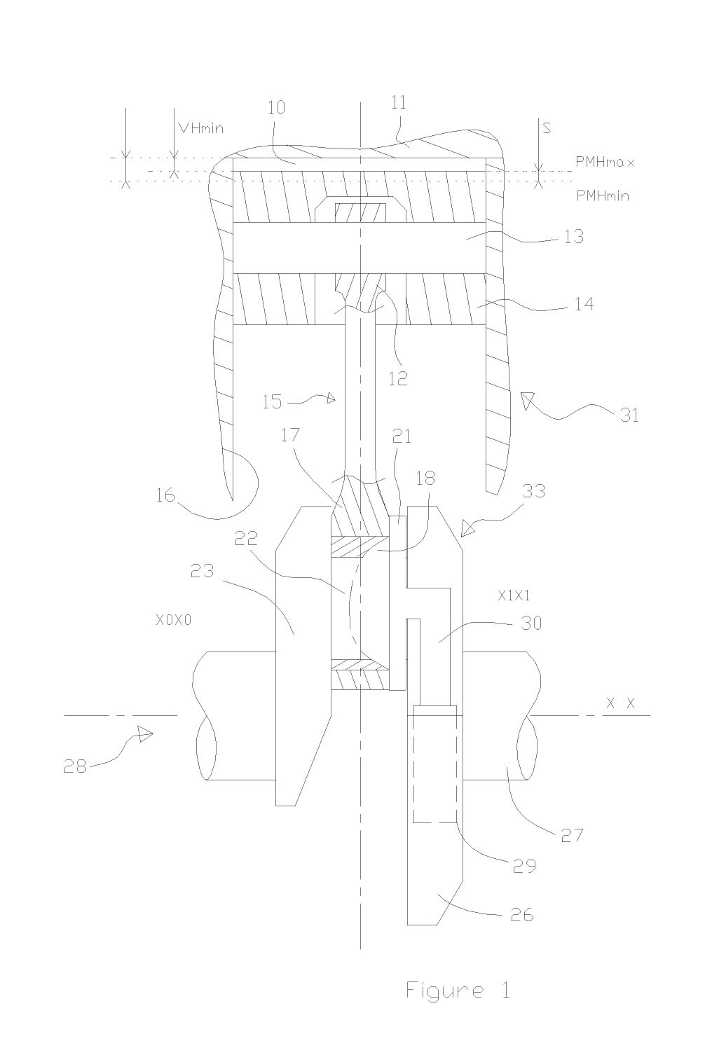

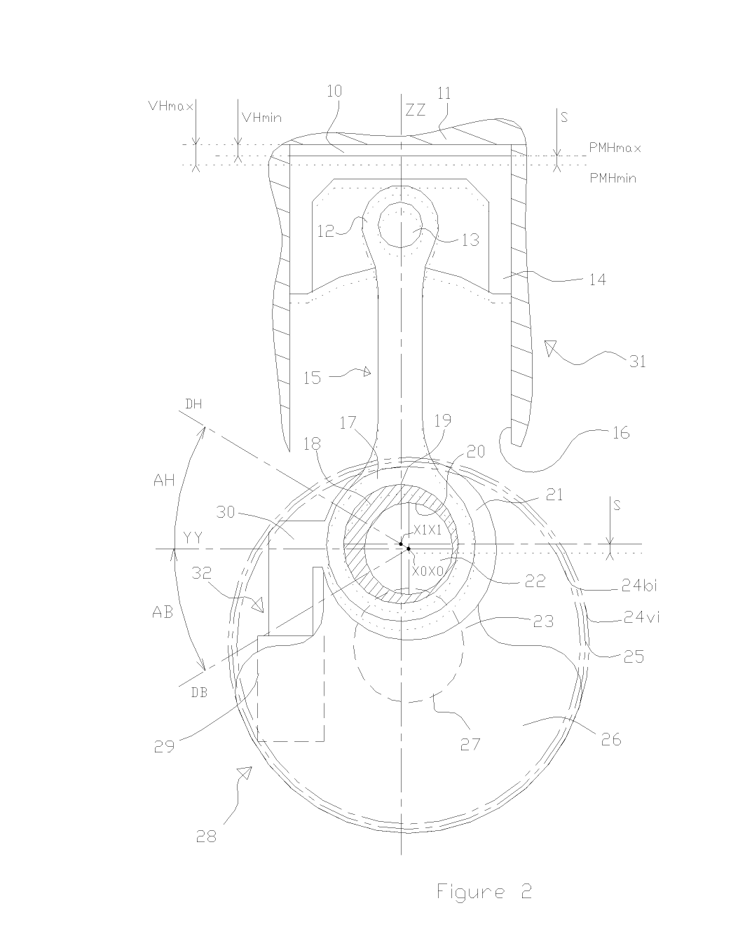

FIGS. 1 and 2 show an internal combustion engine with at least a cylinder 31 which includes/understands a boring 16 inside of which slide a hollow piston 14 in an alternative translative movement under the impulse of a rod 15. This piston delimits with its high part, the side wall of boring 16 and the high part of this boring, generally formed by part of cylinder head 11, a combustion chamber 10 in which is held the cycle of combustion. The piston carries two radial borings diametrically opposite to through which a cylindrical axis 13 is placed which connects the small end 12 audit piston. The big end 17 is connected by a device of adjustment of the compression ratio 32 to a crank pin 22 of a crankshaft 28. This crankshaft 28 is subjected to a rotation movement around an axis XX. As that is known, the piston 14, axis 13, rod 15, crankshaft 28 with its crank pin 22 train the moving element of the engine. In the conventional engines, during the rotation movement of crankshaft 28, the crank pin 22 passes successively from a high position, with a low position. During this movement, the piston 14, which is connected to the crank pin 22 by rod 15, undergoes an alternative translative movement between a top dead center and a dead bottom center. In these engines, when the piston is at the top dead center, either at the end of the phase of compression, or at the end of the phase of exhaust, there remains a volume died in the combustion chamber 10. As the specialist of the profession knows it pertinently, the compression ratio of an engine is a function not only of extended from the volume of the cylinder delimited by the race of the piston but also of the extent of dead volume. To modify the compression ratio, it is enough to modify one of these volumes and more particularly the size of dead volume.

With this intention, the device of adjustment of compression ratio 32 includes/understands an eccentric 18 placed between the crank pin 22 and one boring 19 envisaged in the big end 17. This eccentric 18 has a circular general form with an axis X1X1 which corresponds to its axis medium and includes/understands a boring 20 of axis X0X0 noncoaxial with axis X1X1 but confused with the axis of the crank pin 22. This eccentric is placed with slip in the boring of reception 19 carried out in the big end 17 and peripheral wall of the crank pin 22.

When the piston 14 is at the top dead center, the dead volume of the combustion chamber 10 is a continuous function of the angular orientation of eccentric 18. Indeed, the axis of the big end 17 is confused with axis X1X1 of eccentric 18 and centers it crank pin 22 with axis X0X0 of boring 20 of eccentric 18. However axis X1X1 of eccentric 18 is not coaxial with axis X0X0 of its boring 20. Thus when the piston 14 is at the top dead center, the distance between the axis of the big end 17 and cylinder head 11, is a continuous function of the angular orientation of the eccentric, definite for example by the angle between on the one hand the line passing by its axis X1X1 and axis X0X0 of its boring 20, on the other hand the datum line YY perpendicular to the axis of cylinder 31 and axis X1X1 of eccentric 18. FIG. 2 presents two angular orientations of the eccentric, one in full feature and the other in dotted line, corresponding to two compression ratios different from the internal combustion engine. The angular orientation of eccentric 18 of angles AH between lines YY and DH, lines DH passing by axes X1X1 of eccentric 18 and X0X0 of its boring 20, the high dead point of the piston 14 is PMHmax and corresponds to a dead volume VHmin of the combustion chamber 10. The angular orientation of eccentric 18 correspondent to angle AB between lines YY and dB, when line dB passes by axes X1X1 of eccentric 18 and X0X0 of its boring 20, the high dead point of the piston 14 is PMHmin and corresponds to a dead volume VHmax of the combustion chamber 10. Dead volume VHmax is higher than dead volume VHmin and corresponds to a lower compression ratio of the internal combustion engine.

The device of adjustment of compression ratio 32 also includes methods of control of the displacement of eccentric 18 comprising on the one hand the kinematic connection 30 kinematically related to the flange the 21 which constitutes the radial protuberance interdependent of eccentric 18, on the other hand mechanism of adjustment in position 29 compared to crankshaft 28. The aforementioned mechanism of adjustment in position 29 is integrated in blank 33 of crankshaft 28, this integration being more particularly realized in near total in the mass of balancing 26 of known as crankshaft 28. The aforementioned kinematic connection 30 and the aforementioned mechanism of adjustment in position 29 are integrated entirely apart from the crank pin 22, of stage 27 and the lever 23 connecting the crank pin 22 to stage 27 of crankshaft 28. They occupy a volume whose point furthest away from axis XX of crankshaft 28 described a circle 25, during the rotation of the engine, of a diameter of the same order of magnitude as the largest diameter of the circle 24bi describes by the big end 17 as well as larger diameter of the circle 24vi describes by blanks 33 of crankshaft 28. The kinematic connection 30 does not comprise a bolt and eccentric 18 is of part or form constitutive of a bolt.

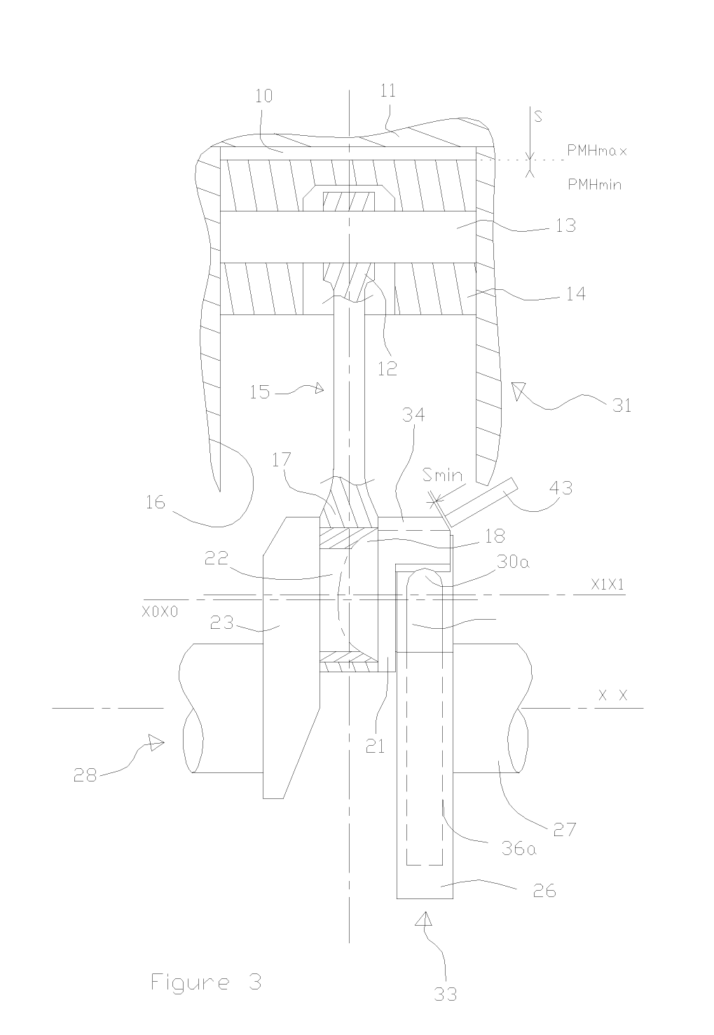

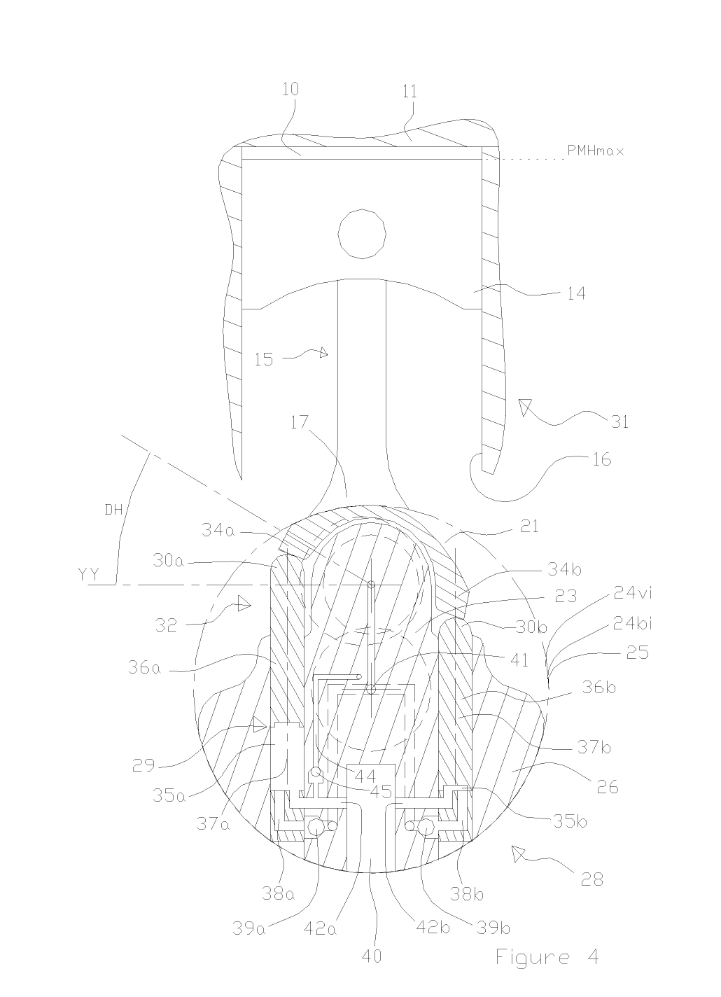

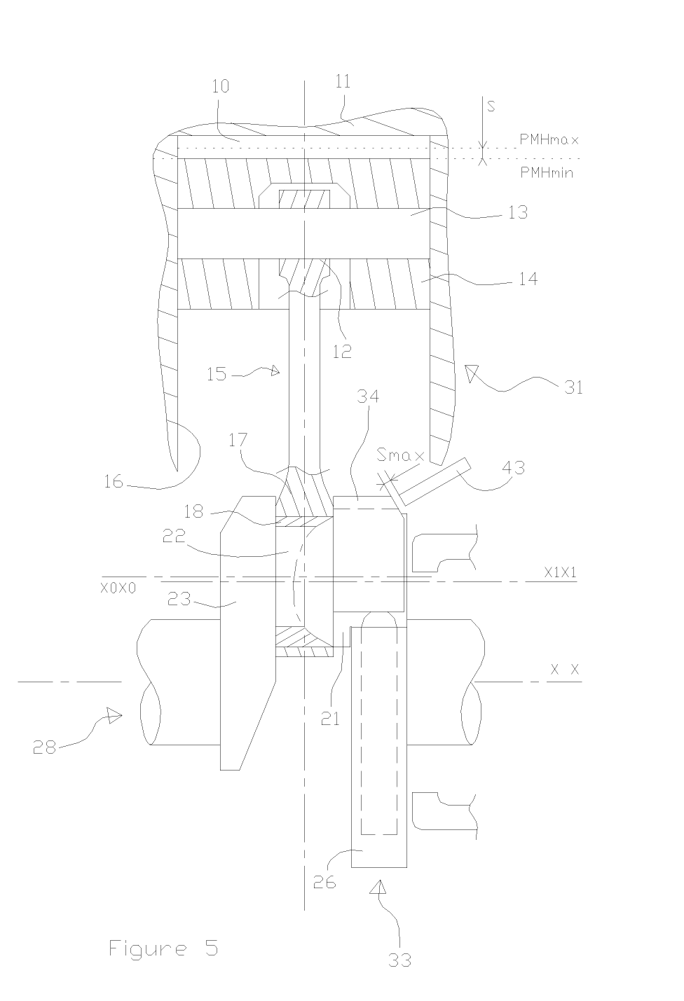

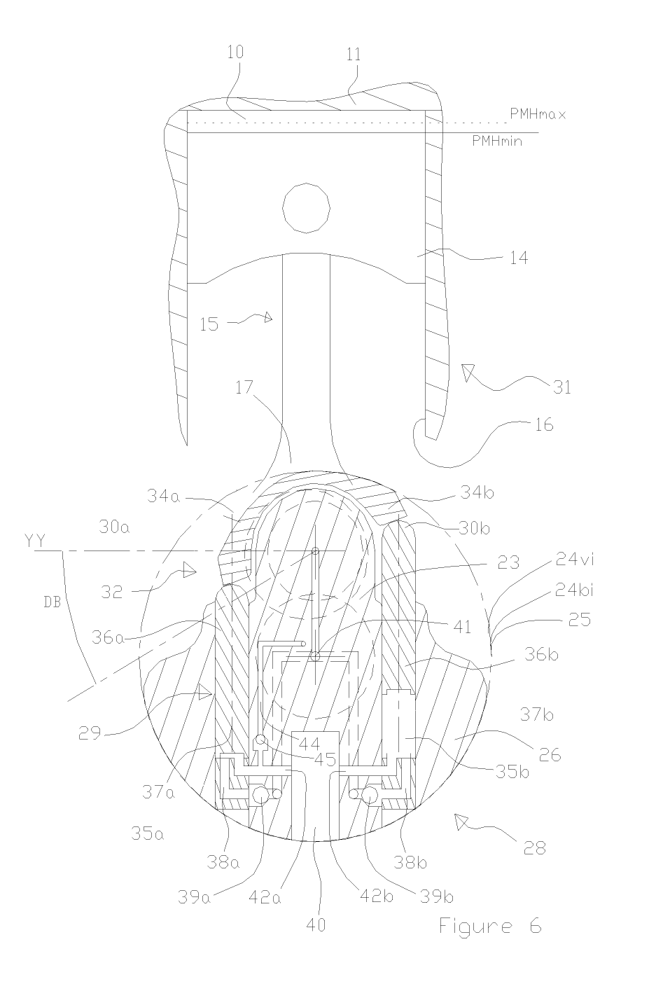

FIGS. 3 to 7 presents the first particular mode preferred of realization according to the invention. Flange 21 interdependent of eccentric 18 forms a rocker with two studs of connection 34a, 34b. The mechanism of adjustment in position 29 compared to crankshaft 28 comprises two linear actuators placed on both sides crank pin 22 and stage 27 of crankshaft 28. These two linear actuators are hydraulic actuating cylinders for simple 36a purpose and 36b from which the axes 37a, 37b are distinct. The kinematic connection 30 between flange 21 and the mechanism of adjustment in position 29 is consisted the top of the stems 30a, 30b of the jacks 36a and 36b which pushes the studs of connection 34a, 34b of the rocker formed by flange 21. The kinematic connection 30 and the mechanism of adjustment in position 29 are integrated entirely apart from the crank pin 22, of stage 27 and the lever 23 connecting the crank pin 22 to stage 27 of the vilebrequin 28. They occupy a volume whose point furthest away from axis XX of crankshaft 28 described a circle 25, during the rotation of the engine, of a diameter equal to the largest diameter of the circle 24bi describes by the big end 17 as well as circle 24vi describes by blanks 33 of crankshaft 28.

Each hydraulic actuating cylinders for simple 36a purpose and 36b works by simple pushes kinematically opposite thanks to the function fulfilled by the rocker articulated around axis X0X0 of boring 20 pertaining to eccentric 18 and confused with the axis of the crank pin 22. An additional advantage of this device of adjustment of the compression ratio is that it does not apply effort of axial direction to eccentric 18. The circulation of oil between the rooms 35a, 35b of the two hydraulic actuating cylinders 36a, 36b is controlled by a hydraulic valve 40 placed in the mass of balancing 26 of crankshaft 28.

The first particular mode preferred of realization according to the invention describes above makes it possible continuously to adjust the compression ratio of the internal combustion engine on its beach of variation. Indeed, each subset constitutive of the device of adjustment of the compression ratio makes it possible to carry out a positioning on any point inside the beach of variation. These subsets are: eccentric 18 solidarized with its flange 21 and its studs 34a, 34b which can be positioned with any angle inside the beach of variation of the angle of positioning of the eccentric 18, the kinematic connection 30a, 30b which is continuous, reversible and free from part constitutive of a bolt, the linear hydraulic actuating cylinders 36a, 36b which can be positioned with any position on their beach of respective variation, from elsewhere they is also reversible, and finally the hydraulic valve 40 which can feed the rooms 35a, 35b of the two hydraulic actuating cylinders 36a, 36b to carry out any positioning inside their beach of variation.

According to the first particular mode preferred of realization according to the invention presented on FIGS. 3 to 6, eccentric 18 is tractor drawn during the operation of the engine and the hydraulic valve 40 makes it possible to authorize or prohibit constantly and for one adjustable length of time, via the hydraulic line 42a, 42b, the oil passage between the rooms 35a, 35b of the two hydraulic actuating cylinders 36a, 36b. This eccentric known as is tractor drawn when it is subjected, during the operation of the engine, with a engine torque of swing drive around axis X0X0, successively in the direction of time rotation of eccentric 18 then in the anti-clockwise direction, generated by the forces due to the various inertias due to displacements of the moving element of the engine in rotation, combined with forces of frictions and the forces resulting from the gas pressures which are exerted on the aforementioned moving element. So that this input torque of eccentric 18 is positive successively in the time direction of rotation of eccentric 18 then in the anti-clockwise direction, and so that it to allow to obtain a beach a variation S of the altitude of the piston 14 at the top dead center, it is necessary to respect the following criteria: an angle of clearance limits eccentric 18 and limiting values of the various influential coefficients of friction. For the realization presented on FIGS. 3 to 6, the beach of variation S of the piston 14 at the high died point is of five millimetres and the diameter of the crank pin 22 of fifty millimetres. The angle of clearance of eccentric 18 is of thirty degrees to the top and thirty degrees to the lower part of the datum line YY. The coefficient of friction of the fluid stage, placed between the boring of the big end 17 and eccentric 18, is lower than five per thousand. The coefficient of friction between the crank pin 22 of crankshaft 28 and eccentric 18 is lower than a tenth. The crank pin 22 of crankshaft 28 is covered with carbon amorphous and lubricated in order to guarantee this higher limit of coefficient of friction. Thus, when the valve 40 puts in communication the rooms 35a, 35b of the two hydraulic actuating cylinders 36a, 36b, eccentric 18 is accelerated in rotation, compared to the crank pin 22 of crankshaft 28, in a direction which depends mainly on the time of the internal combustion engine in its cycle on operation, aspiration or compression or exhaust or explosion or other, of the angle and number of revolutions of crankshaft 28, and the engine load to internal combustion. On the other hand, when valve 40 blocks the oil transits between the rooms 35a, 35b of the two hydraulic actuating cylinders 36a, 36b, the position in rotation of eccentric 18 compared to the crank pin 22 and crankshaft 28 is stopped because oil cannot leave the rooms 35a, 35b of the hydraulic actuating cylinders 36a, 36b and that the aforementioned rooms are free from air. The methods of control of the displacement of the eccentric according to the first preferred mode of realization of the invention thus motorize the eccentric with energy taken directly on the moving element. Only energy necessary to the order of the methods of control of the displacement of the eccentric is taken on the peripherals of the internal combustion engine. This characteristic minimizes energy necessary to the adjustment of the compression ratio.

From elsewhere, in order to eliminate any presence from air in the rooms 35a, 35b of the two hydraulic actuating cylinders 36a, 36b and also in order to compensate for the oil losses which turn over to the cover of the casing of the engine, the rooms 35a, 35b of the two hydraulic actuating cylinders 36a, 36b are gavées out of oil permanently by the pump of lubrication of the engines, via the drains 38a, 38b, the valves non-returns valve 39a, 39b and drain 41 of the usual lubrication of the stage and the crank pin. The direction of assembly of the valves non-returns valve 39a, 39b is such as drain 41 can feed out of oil the rooms 35a, 35b of the hydraulic actuating cylinders 36a, 36b, but the returns of oil of the aforesaid rooms towards drain 41 are blocked.

In order to position the compression ratio to its maximum value when the engine is with the stop, the first mode preferred of realization according to the invention envisages a hydraulic line 44 which connects the room 35a jack 36a of increase in the compression ratio, with a means of generation of water pressure whereas the engine is with the stop, via a non-return valve 45 which prevents oil from returning towards the aforementioned means of generation of water pressure. This option has the advantage of making it possible to immediately turn off the engine, for any value of the compression ratio, as of the request of the user, while being able to have the highest compression ratio in order to facilitate startings of the internal combustion engine by great cold.

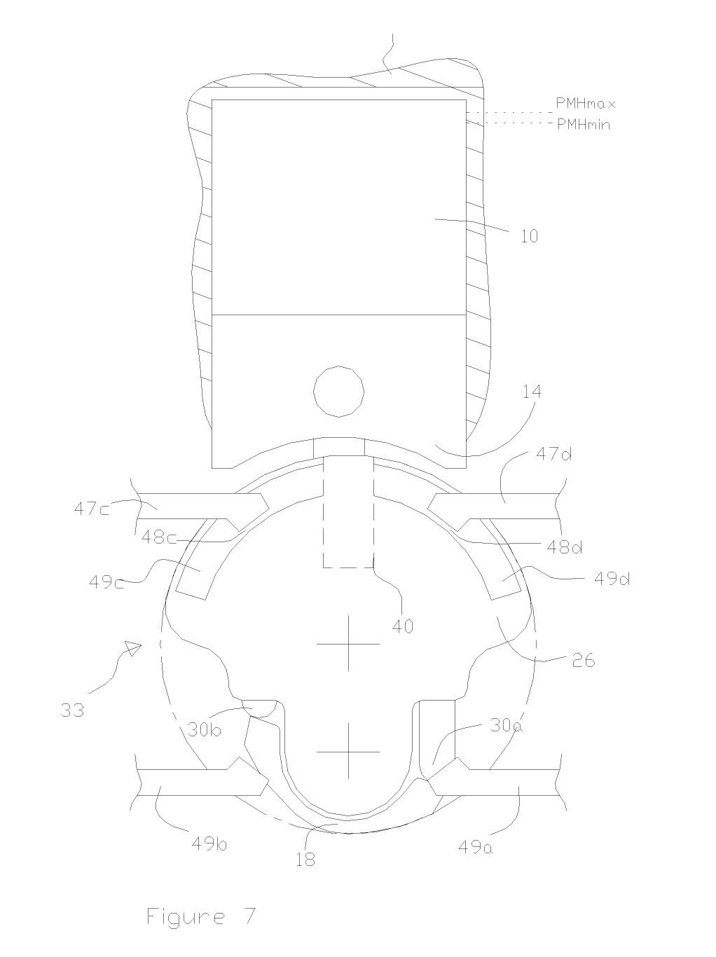

According to the first mode preferred of realization according to the invention, presented on FIG. 7, the hydraulic valve 40 is ordered via an electromagnet. Its electric reel, not represented, is interdependent of the casing of the engine and its mobile core is embarked on the moving element to make it possible to actuate the drawer of the hydraulic valve. The magnetic flux generated by the electric reel forwards in the drivers of magnetic fields 47a, 47b, 47c, 47d interdependent of the casing of the engine, then by plates of air 48c, 48d to reach and circulate in the drivers of magnetic fields 49c, 49d embarked on the moving element, more precisely for this application, embarked on the mass of balancing 26 in blank 33 of crankshaft 28 like in the above mentioned mobile core. This mode of realization has the advantage of a great time life because the electric drive and electromagnetic is transmitted without friction. From elsewhere, more a great choice is possible to place the electric reel without penalizing the obstruction total. The reel can be supplied with continuous electric connections, without the interface of an electrical commutator.

The drawer, not represented, of the hydraulic valve 40 in closed position is on the one hand thorough in the direction of closing by a spring, on the other hand harnessed with a jack for double purpose whose forces which are exerted each with dimensions one of its piston are in balances. When the hydraulic valve 40 is in closed position, the hydraulic rooms of the known as jack for double purpose are fed out of oil under pressure by the rooms 35a, 35b of the jacks 36a, 36b, via valves non-returns valve, not represented, in order to prohibit any communication of hydraulic fluid between the two rooms 35a, 35b of the jacks 36a, 36b by this control circuit. To open the hydraulic valve 40 and to put in communication the two rooms 35a, 35b of the jacks 36a, 36b, the aforementioned mobile core is moved under the action of the magnetic flux generated by the control circuit, which opens a valve and causes the setting with the cover of a hydraulic room of the jack for double purpose so that the fall of pressure in this hydraulic room generates a force of the jack for double purpose in the direction of the opening of the hydraulic valve 40. The pressure losses in the circuit of the aforesaid the setting to the cover under the action of the known as mobile core are much lower than the pressure losses of fuel supply of the above mentioned hydraulic room of the jack for double purpose by the rooms 35a, 35b of the jacks 36a, 36b. The consequence is a fast movement of opening of the hydraulic valve 40. The oil which turns over thus to the cover of the casing of the engine is replaced in the device of adjustment of the compression ratio by oil pressurized by the pump of lubrication of the engine, via the circuit comprising the drains 41,38a, 38b and the valves non-returns valve 39a, 39b describes previously. That makes it possible to obtain a hydraulic assistance with the opening and the closing of the hydraulic valve 40 and thus to carry out the ordering of the device of adjustment of the compression ratio with a low power of the electromagnetic flow which forwards by the magnetic drivers 47a, 47b, 47c, 47d, 49c, 49d.

An alternative of the ordering of the hydraulic valve 40 is presented on FIG. 10. The hydraulic valve 40 is actuated by push rod 52. The mobile cams 51a, 51b actuated by a device not represented allow, during the rotation of the engine, to actuate push rod 52 or not to actuate it according to the order which they receive from the control circuit. The cam 51a makes it possible to open valve 40 when the piston is close to the top dead center and the cam 51b when the piston is close to the dead bottom center.

According to the first mode preferred of realization according to the invention, presented on FIGS. 3 and 5, the compression ratio adjusted by the device is measured by a transmitter of distance without contact 43 fixed on the casing of the engine. This sensor measures the distance which separates it from the point highest reached by the side face of flange 21 interdependent of eccentric 18. The aforementioned side face is of helicoid form of kind and the transmitter of distance without contact is tilted towards the axis of the crankshaft so that the weakest distance measured by the aforementioned sensor is a continuous function of the angular orientation of eccentric 18 compared to the crankshaft. This distance is correlated with the compression ratio by the mechanical kinematics of the device. This distance is thus a reliable image of the compression ratio. This distance is Smax for the minimum compression ratio and Smin for the maximum compression ratio. Advantageously the transmitter of distance without contact is a sensor with eddy current. This type of sensor has the advantage of having a very short response time and a high degree of accuracy.

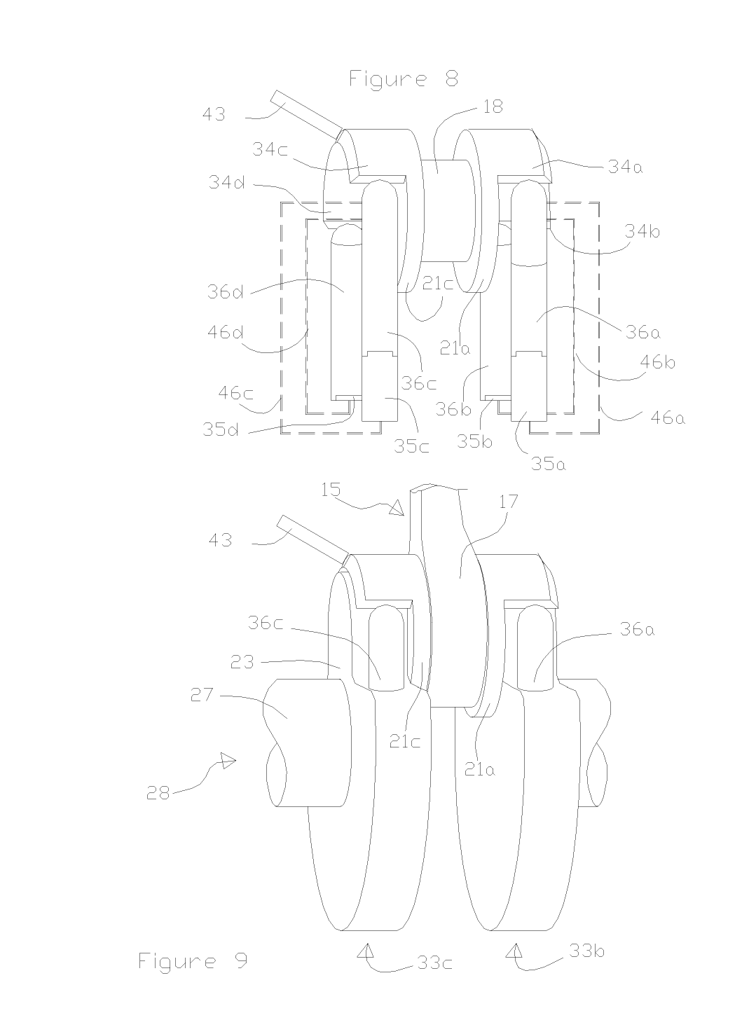

According to a complement with the mode preferred of realization according to the invention, presented on FIGS. 8 and 9, the methods of control of the displacement of eccentric 18 are doubled and placed on both sides eccentric. Eccentric 18 is on the one hand interdependent of a flange 21c placed on the left and controlled in position in particular by the jacks 36c, 36d integrated in the blank 33a of crankshaft 28, on the other hand interdependent of one second flange 21 a located on the right other with dimensions of the rod and controlled in position in particular by the jacks 36a, 36b integrated in the blank 33b of crankshaft 28. This construction doubles the capacity of behavior in couple of control in position of the eccentric. From elsewhere, the hydraulic rooms 35a, 35c of the jacks 36a, 36c of blocking of the rotation of the eccentric clockwise are in communication via the hydraulic line 46a 46c and the hydraulic rooms 35b, 35d of the jacks 36b, 36d of blocking of the rotation of the eccentric in the anti-clockwise direction are in communication via the hydraulic line 46b 46d. This connection makes it possible to standardize the water pressures in each couple of jacks which act in the same direction in order to distribute the constraints and thus to maximize the robustness of the device.

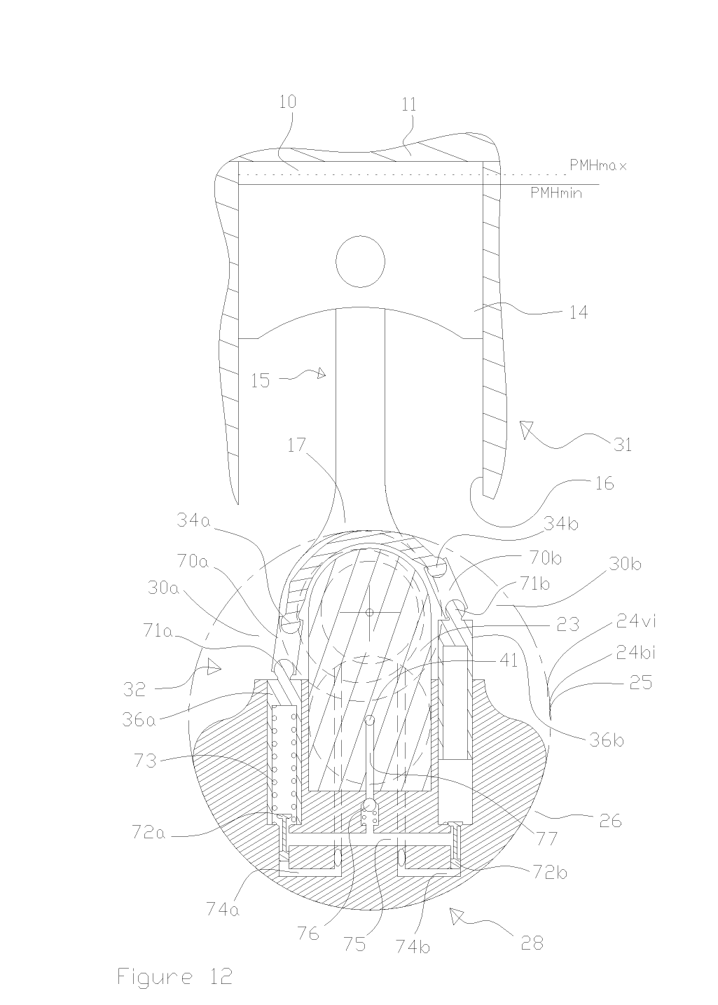

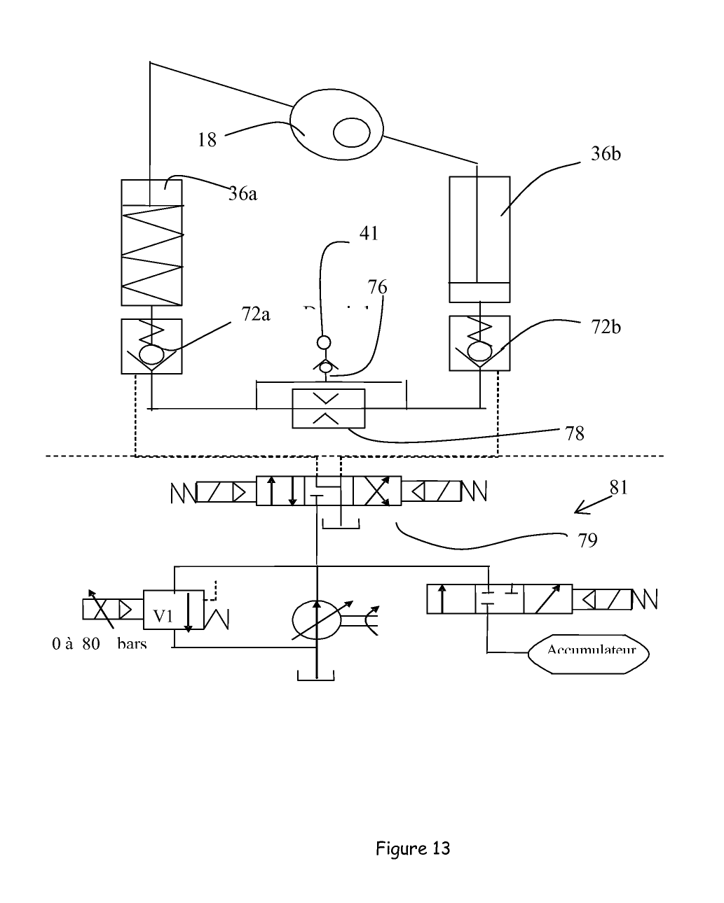

Another manner of carrying out the invention in the hydraulic version is presented on FIGS. 12 and 13. The two hydraulic actuating cylinders 36a and 36b are integrated in a module 80, which module 80 is assembled on crankshaft 28, positioned compared to its lever 23. The two hydraulic actuating cylinders 36a and 36b are equidistant axis X0X0 of the crank pin 22 and the sections of their hydraulic room 35a, 35b are identical. This module 80 integrates the hydraulic system of power including the hydraulic actuating cylinders 36a and 36b, the pilot-operated non-return flap valves 72a and 72b, the non-return valve of cramming 76, drain 75 of communication between the hydraulic actuating cylinders 36a and 36b and the drains of piloting 74a and 74b. This module 80 also fulfills the function of mass of balancing 26. This design has the advantage of making it possible to fulfill and test the hydraulic functions of adjustment of the compression ratio with module 80 independently of crankshaft 28 before the assembly of module 80 on crankshaft 28. The drains of piloting 74a and 74b of the assembled device are connected to annular throats, not represented, carried out on the stage of crankshaft 28. This design has the advantage of making it possible to connect a hydraulic control circuit 81 of the non-return flap valves pilot-operated 72a and 72b, on supports interdependent of the casing of the engine. The circuit of cramming of the hydraulic actuating cylinders 36a and 36b, controlled by the non-return valve 76, is fed by the circuit of lubrication of the engine via drains 41 and 77. The return spring 73 makes it possible to give the compression ratio to the maximum value when the engine is with the stop.

Of share elsewhere, according to the manner of carrying out the invention presented on FIG. 12, the connections kinematics 30a, 30b between flange 21 of eccentric 18 and the stems of the hydraulic actuating cylinders 36a and 36b are carried out using rods 70a and 70b. The articulations between the rods 70a and 70b and respectively flange 21 of eccentric 18 and the stems of the hydraulic actuating cylinders 36a and 36b are carried out respectively by the studs of connection 34a, 34b of hemispherical form and the ball joints 71a and 71b.

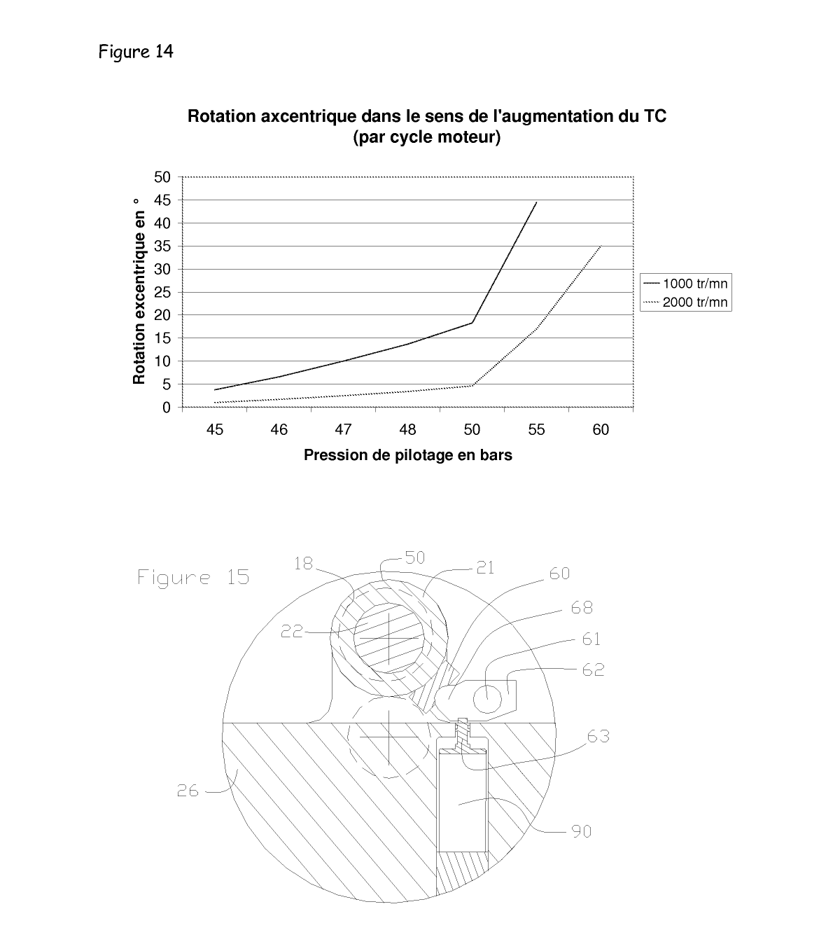

The operation of the device of adjustment of compression ratio 32 according to this other manner of carrying out the invention in hydraulic version is controlled by electromagnetic sluice gate 79 schematized on FIG. 13. When electromagnetic sluice gate 79 pilot in opening the non-return flap valve pilot-operated 72a, the only possible transfers of oil between the two hydraulic actuating cylinders 36a and 36b are those which make it possible to decrease the compression ratio. When electromagnetic sluice gate 79 pilot in opening the non-return flap valve pilot-operated 72b, the only possible transfers of oil between the two hydraulic actuating cylinders 36a and 36b are those which make it possible to increase the compression ratio. This design makes it possible to control one continuously two of the non-return flap valves pilot-operated 72a or 72b during one or more than one driving whole while obtaining a variation of the compression ratio always in the same direction. The advantage lies in the fact that the response time of the hydraulic system of control can be longer, without penalizing the direction wished of variation of the compression ratio. Of share elsewhere, the section of the drawer of each non-return flap valve pilot-operated 72a or 72b of with dimensions of the hydraulic room 35a or 35b of the hydraulic actuating cylinders 36a and 36b is higher than the wetted cross section by the oil of with dimensions of drain 75 of communication between the jacks 36a and 36b. So more the water pressure is high in one of the hydraulic actuating cylinders 36a or 36b, plus the force which tends to close the non-return flap valve pilot-operated 72a or 72b correspondent is high. The non-return flap valve pilot-operated 72a or 72b concerned remains open only if the water pressure of piloting in opening generated by the hydraulic control circuit 81 is sufficient. Consequently, the pressure of piloting generated by the hydraulic control circuit 81 is a parameter of regulation the speed of variation of the compression ratio. An example of graph representing the rotation of the eccentric by driving cycle, for number of revolutions engine of thousand and two miles turns per minute, when one of the valves non-returns valve 72a or 72b is controlled continuously, is presented on FIG. 14. We noted that the amplitude of rotation of eccentric 18 per driving cycle, when the non-return flap valve pilot-operated 72b is controlled, corresponds to an increase in the compression ratio according to an increasing function of the water pressure of piloting generated by the hydraulic control circuit 81. In a similar way, to the piloting of the non-return flap valve pilot-operated 72a, a reduction in the compression ratio corresponds to each driving cycle according to an increasing function of the water pressure of piloting generated by the hydraulic control circuit 81. A contrario, when electromagnetic sluice gate 79 do not control any the non-return valves controlled 72a or 72b, the transfers of oil between the two hydraulic actuating cylinders 36a and 36b are blocked and the compression ratio cannot vary. Throttle valve 78 is component of calibration by construction the speed of variation of the compression ratio. The circuit of cramming via the hydraulic lines 41 and 77 and the non-return valve 76 makes it possible to fill the circuit with oil in initial phase and then to compensate for the possible hydraulic escapes of the system. The role of the non-return valve 76 is to prevent any return of oil of the hydraulic system of power towards the circuit of lubrication of the engine.

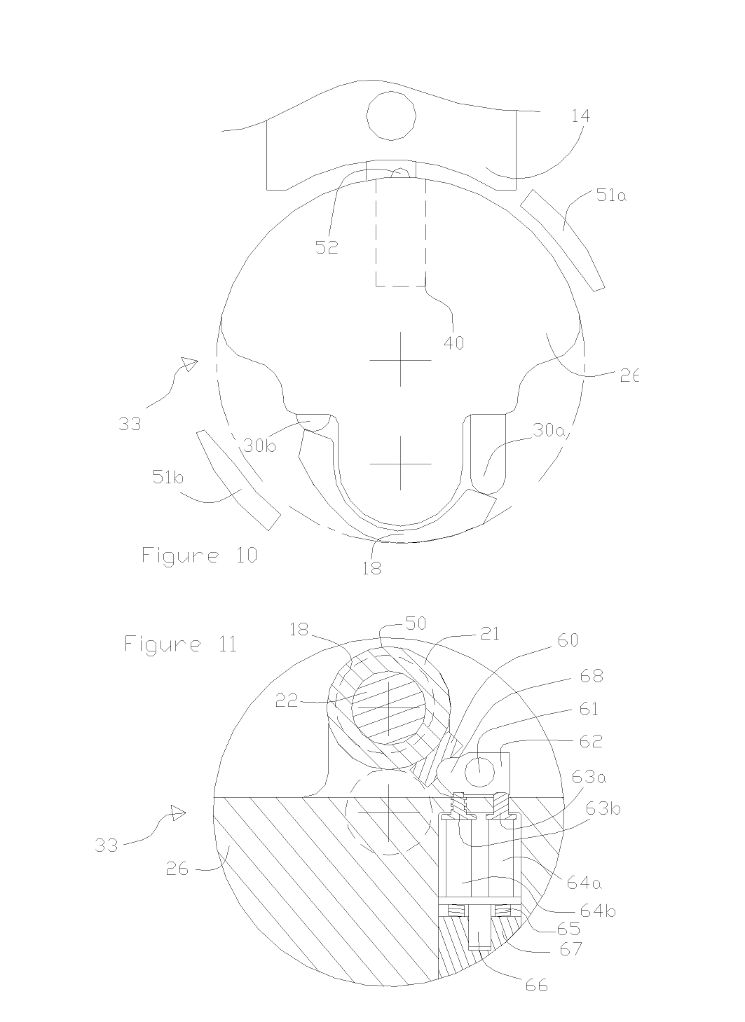

FIG. 11 presents an alternative of realization of the invention. The fluid stage is produced between the crank pin 22 of the crankshaft and boring 20 of eccentric 18. The coefficient of friction of this connection in rotation is lower than five thousandths. The coefficient of friction between boring 19 of the big end 17 and eccentric 18 is higher than thirty five hundredth. This physical characteristic is obtained thanks to a coating of the type titanium nickel deposited vacuum on the diameter external of eccentric 18 and in boring 19 of the big end 17. From elsewhere, this coating confers a great time life at piece-rates treated. The beach of variation S of the piston 14 at the high died point is of five millimetres and the diameter of the crank pin 22 is of fifty millimetres. The angle of clearance of eccentric 18 is of thirty degrees to the top and thirty degrees to the lower part of the datum line YY. Taking into account this construction, the eccentric is never tractor drawn. The means of ordering of the position of the eccentric include/understand a flange 21 interdependent of eccentric 18 and parts integrated in blank 33 of crankshaft 28 made up of a rocker 62 kinematically dependant on a device of actuation and a shoe 60 in contact with the diameter external 50 of flange 21. When the aforementioned device of actuation is ordered by the means of order, not represented, rocker 62 swivels clockwise around its axis 61 interdependent of blank 33 of crankshaft 28 and plates shoe 60 on flange 21. Shoe 60 is retained by articulation 68 interdependent of rocker 62 and cannot thus turn with the eccentric. The unit made up of rocker 62 articulated on axis 61 actuated in rotation clockwise by the device of actuation and of shoe 60 remains related to blank 33 of the crankshaft 28 and induces a direct input torque between the crankshaft and the eccentric.

When this couple is higher than the couple generated by the resultant of the forces which are exerted between the big end 17 and eccentric 18, eccentric 18 is accelerated in the direction of rotation of crankshaft 28. The crankshaft turns in the anti-clockwise direction. When the eccentric is rotated by the crankshaft, the compression ratio increases if axis X1X1 of eccentric 18 is placed, in reference on FIG. 11, on the right by axis X0X0 of its boring and decreases in the contrary case. Thus to reduce or increase the compression ratio, if axis X1X1 of eccentric 18 is placed compared to axis X0X0 of its boring, from with dimensions corresponding within the meaning of variation desired of the compression ratio, the ratio compression varies in the desired direction as soon as the crankshaft actuates the eccentric. In the contrary case, it is necessary to actuate the eccentric in rotation with the crankshaft until the position of axis X1X1 of eccentric 18 compared to axis X0X0 of its boring changes with dimensions to obtain a variation of the compression ratio in the desired direction. This construction makes it possible to control the position in rotation of the eccentric on three hundred and sixty degrees. Consequently the eccentricity between axis X1X1 of the eccentric and axis X0X0 of its boring can be reduced with the lowest value because the rotation of the eccentric can be exploited on three hundred and sixty degrees to adjust the compression ratio. This construction is thus more most compact of all.

A manner of carrying out the invention in electric version, according to the alternative presented to the preceding paragraph, consists in equipping the device with actuation of shoe 60, via rocker 62, of two piezoelectric actuators 64a, 64b. These two actuators 64a, 64b are on two distinct axes, parallel and with the same distance compared to axis 61 of rocker 62. They dealing in direction opposed to make swivel rocker 62, via the push rods 63a, 63b. They are plated with the same geometrical base towards the rocker 62 by cup springs 65 which pushes a guided push rod 66 so that the differential of distance from the piezoelectric base of the actuators 64a, 64b resting against push rod 66 does not change. The travel of the cup springs 65 is more than ten times higher than the travel of the actuators. Thus, some of dilations between the actuators piezoelectric 64a, 64b and the surrounding parts are the usual differentials, the rotation of rocker 62 is always function of the differential of lengthening or retractation between the two actuators 64a, 64b. From elsewhere, the two actuators are always ordered simultaneously and in opposition of tension so that the differentials of temperature between the two actuators piezoelectric 64a, 64b remains weak. The sealing of the two piezoelectric actuators 64a, 64b is ensured by obturator 67 and gaskets, not represented, assembled on the push rods 63a, 63b. The actuators are connected electrically to the means of order via electric wires and swivel joints not represented. The piezoelectric actuators has the advantage of offering response times extremely fast. This construction is thus compatible with internal combustion engines of which the number of revolutions is high. Moreover, the functions of the piezoelectric actuators are reversible. Also, the diameter external 50 of flange 21 interdependent of eccentric 18 with a defect of concentricity of three hundredth of millimetres compared to boring 20 of eccentric 18 and one defect of cylindricity lower than a hundredth of millimetre. Relative rotation between eccentric 18 and crankshaft 28 thus generates variations of efforts on the two piezoelectric actuators 64a, 64b that the latter transform into electrical signals. The aforementioned variations of efforts are correlated with the angular position of the eccentric compared to the crankshaft. The means of order in combination with the knowledge of the angular position of the crankshaft, from of deduced the value from the compression ratio. The piezoelectric actuators thus have the function of actuator to rotate the eccentric with the crankshaft and of transmitter which makes it possible by means of control to know the compression ratio to each turn of the internal combustion engine.

Another manner of carrying out the invention in electric version, according to the alternative presented above to before last paragraph, presented on FIG. 15, consists in equipping the device with actuation of shoe 60, via rocker 62, of only one electric actuator 90 with great race, so that the differentials of dilation and wears are easily compensated.

Of another combination of construction are possible in the perimeter defined by the present invention. Of course, the present invention is not limited to the described modes of realization but includes all alternatives and equivalents.

### POSSIBILITIES OF INDUSTRIAL APPLICATION

The present invention can apply to any machine with piston (S) alternate (S) and more particularly with the internal combustion engines with an aim of reducing the polluting emissions as well as fuel consumption.

1) Device of adjustment of the compression ratio of an internal combustion engine including at least a cylinder 31 with a combustion chamber 10, a moving element comprising a removable piston 14 in translation under the action of a rod 15 bound by an axis 13 audit piston 14 and connected to a crank pin 22 of a crankshaft 28, the aforementioned piston 14 carrying out a race between a top dead center and a dead bottom center while letting remain a volume died at the high dead point of the known as piston 14, the device including between the big end 17 and the crank pin 22 of crankshaft 28 a rotary eccentric 18 allowing to adjust the compression ratio, the device including also methods of control of the displacement of the eccentric, characterized in that the methods of control include/understand at least a kinematic connection 30 without bolt between a radial protuberance interdependent of eccentric 18 and one mechanism of adjustment in position 29 compared to crankshaft 28 comprising at least a linear actuator, the aforementioned mechanism being integrated in one of two blanks 33 of the crankshaft, the aforementioned kinematic connection 30 and the aforementioned mechanism of adjustment in position 29 compared to crankshaft 28 being laid out in major part or entirely apart from the crank pin 22, of stage 27 and the lever 23 connecting the crank pin 22 to stage 27 of crankshaft 28.

2) Device according to claim 1 characterized in that the mechanism of adjustment in position 29 compared to crankshaft 28 is integrated in a volume whose point furthest away from axis XX of the crankshaft describes a circle 25, during the rotation of the engine, of a diameter of the same order of magnitude or lower than the diameter of the largest circle 24bi describes by the big end or of the largest circle 24vi describes by blanks 33 of crankshaft 28

3) Device according to any of the claims 1 characterized in that the methods of control of the displacement of the eccentric according to the invention include/understand two units placed on both sides eccentric 18 and made up each one at least of a kinematic connection 30 without bolt related to a radial protuberance interdependent of eccentric 18 and of a mechanism of adjustment in position 29 compared to crankshaft 28.

4) Device according to any of the claims 1 characterized in that the mechanism of adjustment in position 29 of eccentric 18 compared to crankshaft 28 comprises two linear actuators.

5) Device according to claim 4 characterized in that the axes 37a, 37b of the two linear actuators are distinct.

6) Device according to claim 4 characterized in that the mechanism of adjustment in position 29 compared to crankshaft 28 comprises two hydraulic actuating cylinders for simple 36a purpose and 36b placed on both sides crank pin 22 and stage 27 of crankshaft 28.

7) Device according to claim 4 characterized in that the two linear actuators are two hydraulic actuating cylinders 36a and 36b are integrated in a module 80, which module 80 is assembled on crankshaft 28.

8) Device according to any of the claims 1 characterized in that the means of ordering of the position of the eccentric include/understand a flange 21 interdependent of eccentric 18 and parts integrated in blank 33 of crankshaft 28 made up in particular of a device of actuation and a shoe 60 in contact with the diameter external 50 of flange 21, the shoe which cannot turn with eccentric 18.

9) Device according to claim 8 characterized in that the methods of control of the displacement of eccentric 18 use at least an actuator piezoelectric 64a, 64b.

10) Device according to any of claims 8 for which the fluid stage being realized between the crank pin 22 of the crankshaft and boring 20 of eccentric 18 is characterized in that shoe 60 makes it possible to induce an input torque between the crankshaft and the eccentric, under the action of the device of actuation, to accelerate eccentric 18 in the direction of rotation of crankshaft 28.
